(19) United States
(12) Patent Application Publication
(10) Pub. No.: US 2025/0189782 A1
(43) Pub. Date: Jun. 12, 2025

(54) OPTICAL DEVICE AND IMAGING UNIT INCLUDING OPTICAL DEVICE

(71) Applicant: Murata Manufacturing Co., Ltd., Nagaokakyo-shi (JP)

(72) Inventors: Rei HIGASHIDA, Nagaokakyo-shi (JP); Hitoshi SAKAGUCHI, Nagaokakayo-shi (JP)

(21) Appl. No.: 19/055,575

(22) Filed: Feb. 18, 2025

Related U.S. Application Data
(63) Continuation of application No. PCT/JP2023/015473, filed on Apr. 18, 2023.

(30) Foreign Application Priority Data
Sep. 22, 2022 (JP) 2022-151465

(51) Int. Cl. G02B 27/00

(52) U.S. Cl. CPC G02B 27/0006

(57) ABSTRACT

An optical device is provided that fully removes foreign matter adhering to a surface of a light-transparent body. The optical device includes an outermost-layer lens, a housing, a vibrator, and a piezoelectric device. The outermost-layer lens transmits light of a predetermined wavelength. The housing holds the outermost-layer lens. The vibrator is a tubular body including that contacts the outermost-layer lens and a second end at which the piezoelectric device is disposed. In a heating mode, the vibrator vibrates the outermost-layer lens at a vibration acceleration within a range of more than or equal to 3.0×10⁶ m/s² to less than and or equal to 3.0×10⁸ m/s² at a natural vibration frequency of the outermost-layer lens.

### CROSS REFERENCE TO RELATED APPLICATIONS

This application is a continuation of International Application No. PCT/JP2023/015473, filed Apr. 18, 2023, which claims priority to Japanese Patent Application No. 2022-151465, filed Sep. 22, 2022, the contents of each of which are hereby incorporated by reference in their entirety.

### TECHNICAL FIELD

The present disclosure relates to an optical device, and an imaging unit including an optical device.

### BACKGROUND

With an imaging unit disposed at a front portion or a rear portion of a vehicle and using images obtained by the imaging unit, a safety device is controlled or a driver-assistance control is performed. The imaging unit is usually disposed outside the vehicle, and thus foreign matter such as raindrops (e.g., waterdrops), mud, or dust adheres to a light-transparent body, such as a protective cover or a lens, covering the outside of the imaging unit. In a cold season, ice or frost may adhere to the surface of the light-transparent body of the imaging unit disposed outside the vehicle, and thus, the imaging unit may fail to obtain a clear image.

An optical unit described in U.S. Patent Application Publication No. 2018/0246323 (hereinafter the “‘323 Publication”) can vibrate a light-transparent body at a first frequency (e.g., in a cleaning mode) to remove foreign matter adhering to the surface of the light-transparent body, and vibrate the light-transparent body at a second frequency (e.g., in a heating mode) to heat the light-transparent body. More specifically, the optical unit described in the ‘323 Publication switches the vibration mode for the light-transparent body between a cleaning mode or a heating mode with a controller circuit.

Although the ‘323 Publication describes the imaging unit that vibrates the light-transparent body in a heating mode at the second frequency different from the first frequency, the ‘323 Publication does not describe an imaging unit that vibrates the light-transparent body in a heating mode under restricted conditions in terms of, for example, allowable power consumption or allowable wait time. Thus, the imaging unit described in the ‘323 Publication fails to fully remove foreign matter, such as ice or frost, adhering to the surface of the light-transparent body under restricted conditions.

### SUMMARY OF THE INVENTION

In view of the foregoing, the present disclosure provides an optical device configured to fully remove foreign matter adhering to the surface of a light-transparent body under restricted conditions, and to provide an imaging unit including the optical device.

In an exemplary aspect, an optical device is provided that includes a light-transparent body that transmits light of a predetermined wavelength, a housing that holds the light-transparent body, a vibrator that comes into contact with the light-transparent body held by the housing, and a piezoelectric device disposed at the vibrator to vibrate the vibrator. In this aspect, the vibrator is a tubular body, and has a first end that contacts the light-transparent body, and a second end, opposite to the first end, at which the piezoelectric device is disposed. In a heating mode among multiple vibration modes of vibrating the light-transparent body, the vibrator vibrates the light-transparent body at a vibration acceleration within a range of more than or equal to 3.0×10⁶ m/s² to less than or equal to 3.0×10⁸ m/s² at a natural vibration frequency of the light-transparent body.

Moreover, an imaging unit according to an exemplary aspect includes the optical device described above, and an imaging device oriented to have the light-transparent body in a direction of the field of view.

According to the exemplary aspects of the present disclosure, a vibrator is configured to vibrate the light-transparent body in a heating mode at a vibration acceleration within a range of more than or equal to 3.0×10⁶ m/s² to less than or equal to 3.0×10⁸ m/s² at a natural vibration frequency of the light-transparent body, and thus is configured to fully remove foreign matter adhering to the surface of the light-transparent body under restricted conditions.

### BRIEF DESCRIPTION OF DRAWINGS

FIG. 1 is a half-sectional diagram of an imaging unit according to an exemplary embodiment.

FIG. 2 is a schematic diagram describing displacement caused in an optical device according to an exemplary embodiment.

FIG. 3 is a graph describing a vibration acceleration and a temperature rise rate when a lens is vibrated in a heating mode and a vibration mode of a comparative example.

FIG. 4 is a graph describing a relationship between a frequency and a resonant resistance when an outermost-layer lens according to an exemplary embodiment is vibrated in a heating mode.

FIG. 5 is a graph describing a relationship between a frequency and an electromechanical coupling coefficient when an outermost-layer lens according to an exemplary embodiment is vibrated in a heating mode.

FIG. 6 is a schematic diagram describing displacement caused in an optical device not satisfying set conditions.

FIGS. 7 (a) and 7 (b) are schematic diagrams describing displacement of an outermost-layer lens 1 when a vibrator according to an exemplary embodiment is driven in a foreign-matter removal mode.

FIG. 8 is a schematic diagram describing displacement of an outermost-layer lens 1 when a vibrator according to an exemplary embodiment is driven in another foreign-matter removal mode.

### DETAILED DESCRIPTION OF EMBODIMENTS

An optical device according to exemplary an embodiment, and an imaging unit according to an exemplary embodiment including the optical device are described below in detail with reference to the drawings. It is noted that the same reference signs throughout the drawings denote the same or equivalent components. According to exemplary aspects, the optical device described below can be applied to, for example, a vehicle-mounted imaging unit, and can vibrate a light-transparent body (for example, an outermost-layer lens) to remove foreign matter adhering to the surface of the light-transparent body. It should be appreciated that the purpose of use of the optical device is not limited to a vehicle-mounted imaging unit. The optical device can also be applicable to, for example, a security surveillance camera or an imaging unit for a drone.

### Exemplary Embodiment

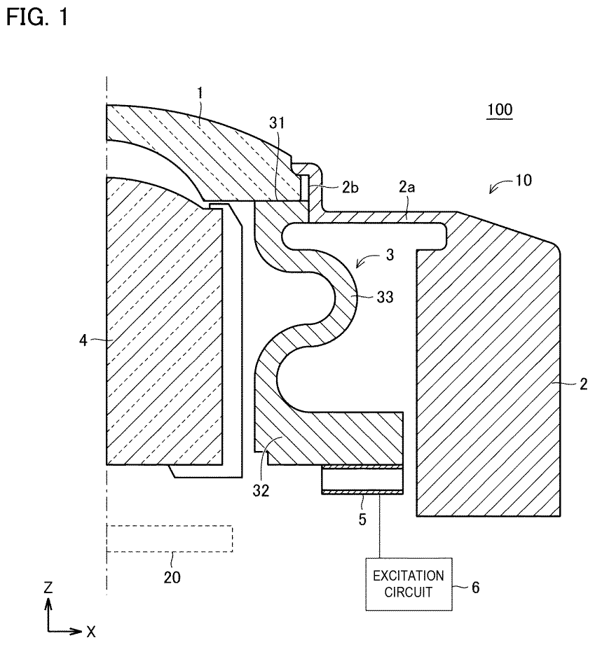

FIG. 1 is a half-sectional diagram of an imaging unit 100 according to an exemplary embodiment. In the drawings and for purposes of this disclosure, an X-direction and a Z-direction respectively denote the lateral direction and the height direction of the imaging unit 100. A dot-and-dash line in FIG. 1 passes through the center axis of the imaging unit 100. The imaging unit 100 includes an optical device 10, and an imaging device 20 oriented to have an outermost-layer lens 1 and an inner layer lens 4 in a direction of the field of view. The imaging device 20 is an image sensor, such as a charge coupled device (CCD) or a complementary metal-oxide-semiconductor (CMOS) sensor, and is mounted on a circuit board not illustrated.

As further shown, the optical device 10 includes the outermost-layer lens 1, a housing 2, a vibrator 3, the inner layer lens 4, a piezoelectric device 5, and an excitation circuit 6. In the present disclosure, the optical device 10 may at least include the outermost-layer lens 1, the housing 2, the vibrator 3, and the piezoelectric device 5, and either the inner layer lens 4 or the excitation circuit 6, or the inner layer lens 4 and the excitation circuit 6 may be included in the imaging unit 100. After alignment adjustment between the outermost-layer lens 1 and the inner layer lens 4 is performed in the optical device 10, and a casing containing the imaging device 20 is attached to the optical device 10, the imaging unit 100 is prepared.

In the exemplary embodiment, the outermost-layer lens 1 is a light-transparent body that is configured to transmit light of a predetermined wavelength (for example, a wavelength of visible light or a wavelength that can be captured by an imaging device), and is, for example, a convex meniscus lens. Instead of the outermost-layer lens 1, the optical device 10 may include a transparent member, such as a protective cover in another exemplary aspect. The protective cover is formed from glass or resin, such as transparent plastics, in an exemplary aspect.

Moreover, the end portion of the outermost-layer lens 1 is held at the end portion of a flat spring 2a extending from the housing 2. A space between the outermost-layer lens 1 and a retainer 2b, serving as an end portion of the flat spring 2a, is filled with an adhesive. In addition, the optical device 10 includes the vibrator 3 located to be in contact with the outermost-layer lens 1 to vibrate the outermost-layer lens 1 held by the housing 2.

The vibrator 3 is a tubular body, and has a first end portion 31 (e.g., a first end) that is in contact with the outermost-layer lens 1, and a second end portion 32 (e.g., a second end) that is opposite to the first end portion and at which the piezoelectric device 5 is disposed. In the vibrator 3, a supporter 33 connects the first end portion 31 to the second end portion 32. The supporter 33 has an S-shaped cross section. As illustrated in FIG. 1, the inner layer lens 4 is disposed in the tube of the vibrator 3.

In the exemplary aspect, the first end portion 31 extends in the radial direction (the X-direction and the Y-direction) of the tubular body and can be stably connected to the edge portion of the outermost-layer lens 1. The second end portion 32 is configured to vibrate together with vibrations of the piezoelectric device 5 and has a larger thickness than other portions. Thus, the vibrations of the piezoelectric device 5 can be more efficiently propagated to the outermost-layer lens 1. The supporter 33 supports the first end portion 31 and propagates vibrations of the second end portion 32 to the first end portion 31. The first end portion 31, the second end portion 32, and the supporter 33 may be formed integrally or separately in various exemplary aspects. As illustrated in FIG. 1, the maximum outer dimensions of the supporter 33 are greater than the maximum outer dimensions of the first end portion 31, and the maximum outer dimensions of the second end portion 32 are greater than the maximum outer dimensions of the supporter 33. Thus, vibrations of the second end portion 32 (more specifically, vibrations of the piezoelectric device 5) can be efficiently propagated to the outermost-layer lens 1 (e.g., a light-transparent body).

The piezoelectric device 5 is disposed at the second end portion 32. The piezoelectric device 5 has a hollow circular shape and is configured to vibrate by being polarized in a thickness direction, for example. The piezoelectric device 5 can be formed from PZT-based piezoelectric ceramics. Alternatively, other piezoelectric ceramics, such as (K, Na) NbO₃, can be used. Moreover, a piezoelectric single crystal, such as LiTaO₃, can be used. The piezoelectric device 5 is connected to the excitation circuit 6 and is configured to vibrate the outermost-layer lens 1 based on a signal from the circuit.

To remove foreign matter. such as raindrops, mud, or dust, adhering to the outermost-layer lens 1, the excitation circuit 6 is configured to drive the piezoelectric device 5 in a foreign-matter removal mode in which the outermost-layer lens 1 is vibrated at a resonant frequency of the vibrator 3. To remove foreign matter, such as ice or frost, adhering to the outermost-layer lens 1, the excitation circuit 6 is configured to drive the piezoelectric device 5 in a heating mode in which the outermost-layer lens 1 is vibrated at a natural vibration frequency of the outermost-layer lens 1. The excitation circuit 6 can be configured to drive the piezoelectric device 5 while switching between vibration modes including the foreign-matter removal mode and the heating mode. The excitation circuit 6 also serves as a switching portion (or switching controller) that is configured to switch the mode of vibrating the outermost-layer lens 1 between multiple vibration modes.

In the heating mode, the outermost-layer lens 1 is heated using a mechanical loss of vibrations caused by vibrating the outermost-layer lens 1. To efficiently heat the outermost-layer lens 1, the outermost-layer lens 1 is to be vibrated at a natural vibration frequency of the outermost-layer lens 1. However, even when the outermost-layer lens 1 is vibrated at the natural vibration frequency, the imaging unit 100 fails to capture required images while foreign matter, such as ice or frost, adheres to the outermost-layer lens 1. Thus, in a system in which the imaging unit 100 is installed (for example, a vehicle-mounted system), time, which can be considered an allowable wait time, taken in the heating mode to remove foreign matter, such as ice or frost, to be prepared for capturing required images is limited.

The optical device 10 is configured to increase the vibration acceleration of the outermost-layer lens 1 to increase the heat generated by the outermost-layer lens 1. For example, when the allowable wait time is limited to about 200 seconds to 400 seconds, it is found after repeated simulations that the vibration acceleration of the outermost-layer lens 1 required to remove foreign matter, such as ice or frost, adhering to the outermost-layer lens 1 within the allowable wait time reaches or exceeds approximately 3.0×10⁶ m/s².

Thus, the optical device 10 can be configured to remove foreign matter, such as ice or frost, adhering to the outermost-layer lens 1 within the allowable wait time by vibrating the outermost-layer lens 1 while increasing the vibration acceleration of the outermost-layer lens 1 to reach or exceed approximately 3.0×10⁶ m/s². It should be appreciated that the optical device 10 can reduce time taken to remove foreign matter, such as ice or frost, adhering to the outermost-layer lens 1 by further increasing the vibration acceleration of the outermost-layer lens 1. However, as the vibration acceleration of the outermost-layer lens 1 is increased further, more power is consumed by the piezoelectric device 5.

In a system in which the imaging unit 100 is installed (for example, in a vehicle-mounted system), the power consumption, which can be considered the allowable power consumption, allocated to the imaging unit 100 is usually limited. Thus, in the optical device 10, foreign matter, such as ice or frost, adhering to the outermost-layer lens 1 is to be removed by vibrating the outermost-layer lens 1 within the range of allowable power consumption. For example, when the allowable power consumption is limited to approximately 3 W to 7 W, it is found after repeated simulations and experiments that the vibration acceleration of the outermost-layer lens 1 at which the outermost-layer lens 1 can vibrate within the allowable power consumption is less than or equal to approximately 3.0×10⁸ m/s².

Thus, to vibrate the outermost-layer lens 1 in the heating mode under restricted conditions, such as an allowable power consumption and allowable wait time, the optical device 10 preferably vibrates the outermost-layer lens 1 at a vibration acceleration within a range of more than or equal to approximately 3.0×10⁶ m/s² to less than or equal to approximately 3.0×10⁸ m/s² at a natural vibration frequency of the outermost-layer lens 1. More preferably, the optical device 10 is configured to vibrate the outermost-layer lens 1 at a vibration acceleration within a range of more than or equal to approximately 3.0×10⁶ m/s² to less than or equal to approximately 4.9×10⁷ m/s² at a natural vibration frequency of the outermost-layer lens 1. The optical device 10 can be configured to fully remove foreign matter, such as ice or frost, adhering to the surface of the outermost-layer lens 1 under restricted conditions by vibrating the outermost-layer lens 1 in the above heating mode.

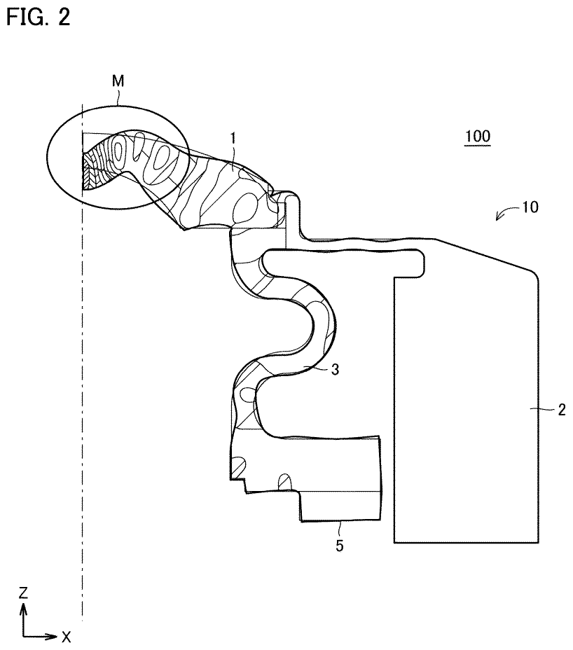

The optical device 10 can be further configured to remove foreign matter, such as ice or frost, adhering to the surface of the outermost-layer lens 1 by vibrating the outermost-layer lens 1 in the heating mode, but can further efficiently remove foreign matter by causing the outermost-layer lens 1 to have maximum displacement resulting from vibrations. FIG. 2 is a schematic diagram describing displacement caused in the optical device 10 according to an embodiment. FIG. 2 illustrates displacement resulting from vibrations in the optical device 10 after a simulation of vibrating the optical device 10 is performed. The dot-and-dash line illustrated in FIG. 2 passes through the center axis of the optical device 10. In FIG. 2, the density of hatching corresponds to an amount of displacement resulting from vibrations, for example, a portion with thick hatching corresponds to a portion with a large amount of displacement resulting from vibrations.

As is clear from FIG. 2, a center portion M of the outermost-layer lens 1 is greatly deformed. In contrast, other portions are deformed less than a center portion M. Specifically, when vibrating the outermost-layer lens 1 in the heating mode, the optical device 10 can be configured to vibrate the outermost-layer lens 1 to cause the outermost-layer lens 1 to have the maximum displacement resulting from vibrations. When the optical device 10 vibrates the outermost-layer lens 1 in the heating mode in this manner, the energy input by the piezoelectric device 5 can be efficiently consumed as the heat of the outermost-layer lens 1.

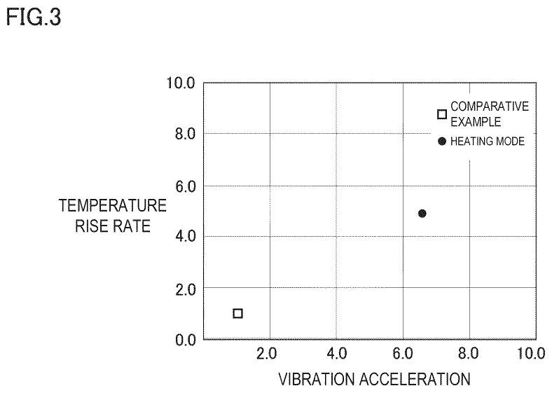

FIG. 3 illustrates experiment data in which a vibration mode of a comparative example and the heating mode are compared in terms of a vibration acceleration and a temperature rise rate. In FIG. 3, the vibration acceleration and the temperature rise rate when the outermost-layer lens 1 is vibrated in the heating mode are illustrated while the vibration acceleration and the temperature rise rate when the outermost-layer lens 1 is vibrated in the vibration mode of the comparative example are defined as “1”. Both vibration modes are driven with equivalent power consumption, and the allowable power consumption is within the range of 3 W to 7 W. The vibration acceleration of the vibration mode of the comparative example falls below the lower limit of the limited range of 3.0×10⁶ m/s². As is clear from FIG. 3, in the heating mode, the vibration acceleration is approximately 6.7 times of that in the comparative example, and the temperature rise rate is approximately 5.0 times of that in the comparative example. Thus, when the outermost-layer lens 1 is vibrated in the heating mode, a temperature rise rate faster than that achieved when the outermost-layer lens 1 is vibrated in the vibration mode of the comparative example can be achieved, and thus, the input energy (e.g., power consumption) can be more efficiently consumed by the temperature rise, such as thawing. More specifically, the optical device 10 can more efficiently remove foreign matter, such as ice or frost, than when the outermost-layer lens 1 does not have maximum displacement resulting from vibrations.

By vibrating the outermost-layer lens 1 at the natural vibration frequency of the outermost-layer lens 1, the optical device 10 can increase, of the energy input through the piezoelectric device 5, the rate of energy allocated to the outermost-layer lens 1. Thus, the vibration acceleration of the outermost-layer lens 1 can be increased, and the outermost-layer lens 1 can have the maximum displacement resulting from vibrations.

For the optical device 10 to efficiently convert the energy allocated to the outermost-layer lens 1 into heat energy, the electromechanical coupling coefficient between the outermost-layer lens 1 and the piezoelectric device 5 is to be optimized.

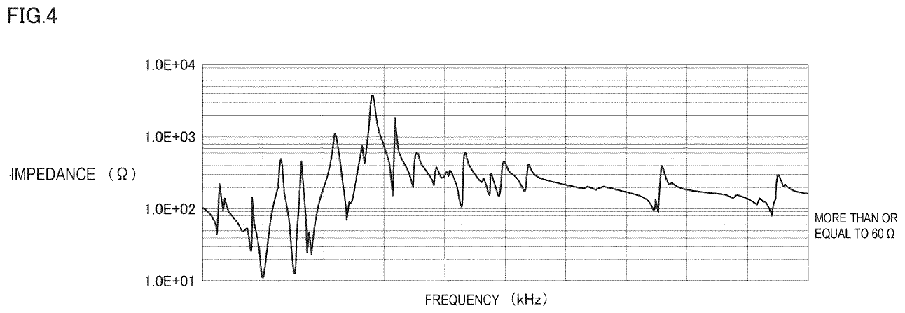

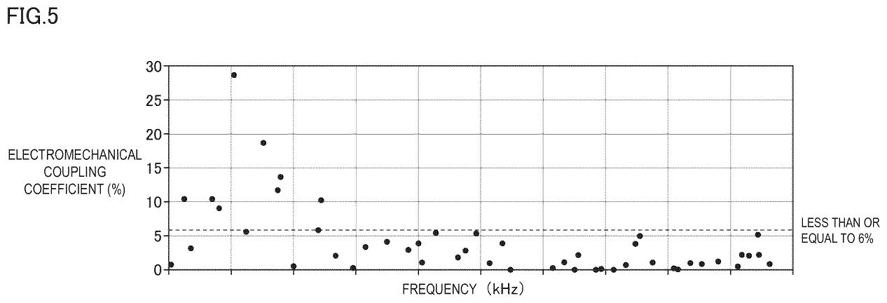

FIG. 4 is a graph describing a relationship between a frequency and a resonant resistance when the outermost-layer lens according to an embodiment is vibrated in the heating mode. In FIG. 4, the horizontal axis indicates the frequency (kHz) of the piezoelectric device 5, and the vertical axis indicates the resonant resistance (Q) of the vibrator 3 including the outermost-layer lens 1. FIG. 5 is a graph describing a relationship between a frequency and an electromechanical coupling coefficient when the outermost-layer lens 1 according to an embodiment is vibrated in the heating mode. In FIG. 5, the horizontal axis indicates the frequency (kHz) of the piezoelectric device 5, and the vertical axis indicates the electromechanical coupling coefficient (%) between the outermost-layer lens 1 and the piezoelectric device 5. Data pieces plotted in FIG. 4 and FIG. 5 are vibration simulation results obtained when the energy allocated to the outermost-layer lens 1 is successfully converted into heat energy with efficiency of higher than or equal to a predetermined value.

FIG. 4 illustrates that the resonant resistance is preferably higher than or equal to 60 Ω when the optical device 10 vibrates the outermost-layer lens 1 to efficiently convert the energy allocated to the outermost-layer lens 1 into the heat energy. In addition, FIG. 5 illustrates that the electromechanical coupling coefficient between the outermost-layer lens 1 and the piezoelectric device 5 is preferably within the range of more than or equal to 0% and less than or equal to 6% when the optical device 10 vibrates the outermost-layer lens 1 to efficiently convert the energy allocated to the outermost-layer lens 1 into the heat energy.

When the optical device 10 vibrates the outermost-layer lens 1 in the heating mode while satisfying the set condition where the electromechanical coupling coefficient between the outermost-layer lens 1 and the piezoelectric device 5 is within the range of more than or equal to 0% to less than or equal to 6%, or where the resonant resistance is more than or equal to 60 Ω, the optical device 10 vibrates the outermost-layer lens 1 in a vibration mode that is not superimposed on a higher-order resonant mode of the piezoelectric device 5. Thus, the optical device 10 can efficiently convert the energy allocated to the outermost-layer lens 1 into the heat energy and allows the outermost-layer lens 1 to efficiently generate heat.

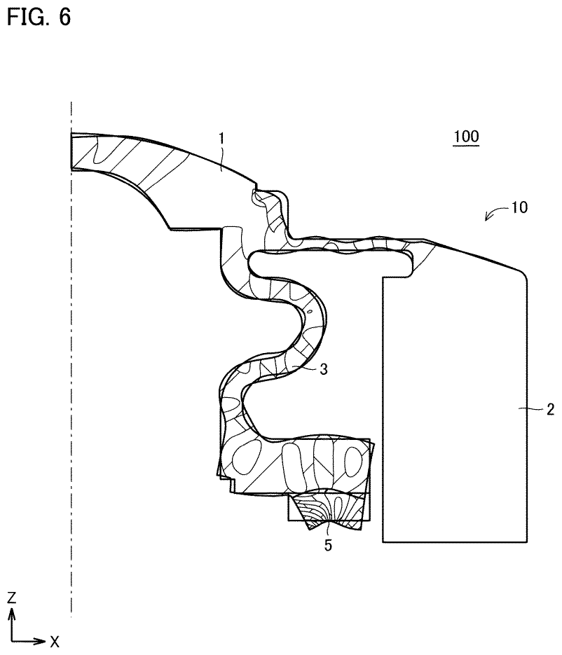

When the optical device 10 fails to satisfy the set condition, for example, when the electromechanical coupling coefficient between the outermost-layer lens 1 and the piezoelectric device 5 exceeds 6% or the resonant resistance falls below 60 Ω, displacement resulting from vibrations at a portion other than the outermost-layer lens 1 increases, and heat from this portion increases. FIG. 6 is a schematic diagram describing displacement caused in the optical device 10 not satisfying the set condition.

FIG. 6 illustrates the result of a vibration simulation performed on the optical device 10 having the electromechanical coupling coefficient between the outermost-layer lens 1 and the piezoelectric device 5 larger than 6% or the resonant resistance smaller than 60 Ω. The dot-and-dash line illustrated in FIG. 6 passes through the center axis of the optical device 10. In FIG. 6, the density of hatching corresponds to an amount of displacement resulting from vibrations, for example, a portion with thick hatching corresponds to a portion with a large amount of displacement resulting from vibrations.

When the optical device 10 failing to satisfy the set condition is vibrated, the optical device 10 vibrates in a vibration mode that is superimposed on a higher-order resonant mode of the piezoelectric device 5, and, as illustrated in FIG. 6, the piezoelectric device 5 has a larger amount of displacement than the displacement of the outermost-layer lens 1. The portion that has a large amount of displacement serves as a heat source. Thus, in the case of FIG. 6, the energy consumed by heat generation in the piezoelectric device 5 is larger than the energy consumed by heat generation in the outermost-layer lens 1. When the outermost-layer lens 1 has a small amount of displacement, the energy allocated to the outermost-layer lens 1 fails to be efficiently converted into the heat energy.

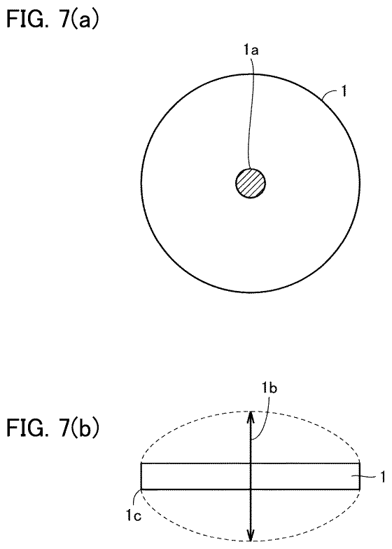

In addition to driving the piezoelectric device 5 in the heating mode, the optical device 10 can be configured to drive the piezoelectric device 5 in a foreign-matter removal mode in which the outermost-layer lens 1 is vibrated at a resonant frequency of the vibrator 3 to remove foreign matter, such as raindrops, mud, or dust, adhering to the outermost-layer lens 1. FIGS. 7 (a) and 7 (b) are schematic diagrams describing displacement of the outermost-layer lens 1 when the vibrator 3 according to an embodiment is driven in the foreign-matter removal mode.

In particular, FIG. 7 (a) illustrates a position of maximum displacement of the outermost-layer lens 1 when the vibrator 3 is driven in the foreign-matter removal mode. FIG. 7 (b) illustrates the vibration amplitude when the outermost-layer lens 1 assumed as a flat board is vibrated in the foreign-matter removal mode.

When the optical device 10 drives the piezoelectric device 5 at the resonant frequency of the vibrator 3, the optical device 10 can be configured to vibrate the outermost-layer lens 1 in the foreign-matter removal mode. When the outermost-layer lens 1 is vibrated in the foreign-matter removal mode, as illustrated in FIG. 7 (a), the outermost-layer lens 1 has maximum vibration displacement at a center portion 1a. As illustrated in FIG. 7 (b), when the outermost-layer lens 1 is assumed as a flat board, a portion with a large amount of displacement serves as the center portion 1a (i.e., a vibration antinode 1b) of the outermost-layer lens 1, and a portion with a small amount of displacement serves as an edge portion (i.e., a vibration node 1c) of the outermost-layer lens 1.

The vibrator 3 can be configured to vibrate the outermost-layer lens 1 in the foreign-matter removal mode among the multiple vibration modes at the resonant frequency at which the center portion la of the outermost-layer lens 1 serves as the vibration antinode 1b, and at which the edge portion of the outermost-layer lens 1 held at the housing 2 serves as the vibration node 1c. Thus, the optical device 10 can remove the foreign matter, such as raindrops, mud, or dust, adhering to the outermost-layer lens 1 by vibrating the outermost-layer lens 1.

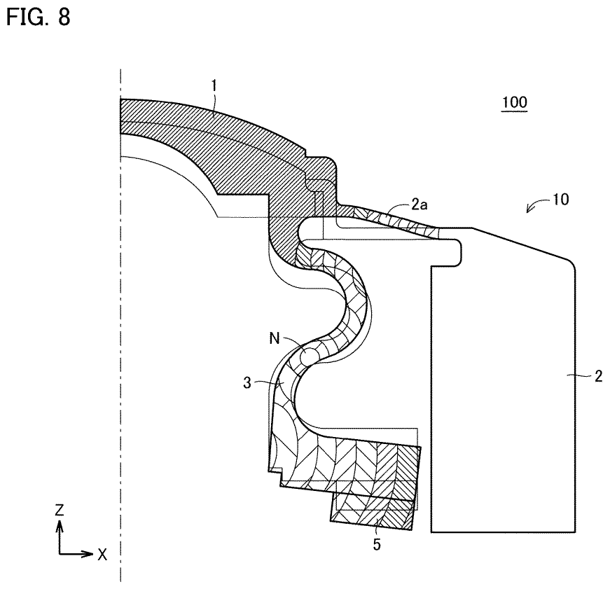

It is noted that the foreign-matter removal mode is not limited to the vibrations illustrated in FIGS. 7 (a) and 7 (b). FIG. 8 is a schematic diagram describing displacement of the outermost-layer lens 1 when a vibrator according to an embodiment is driven in another foreign-matter removal mode. As is clear from FIG. 8, the vibrator 3 displaces the entirety of the outermost-layer lens 1 in a Z-direction (a direction of the field of view) by elastically deforming the outermost-layer lens 1 like a spring. The vibrations of the vibrator 3 also elastically deform the flat spring 2a of the housing 2 that holds the outermost-layer lens 1. As is clear from FIG. 8, the vibrator 3 has a vibration node N at the center portion of the portion having an S-shaped cross section. The vibration node N has an amplitude that is less than or equal to approximately one fiftieth of the maximum amplitude of the vibrator 3. Thus, vibrations of the vibrator 3 maximize the displacement of the outermost-layer lens 1, but reduce the displacement of the vibration node N. In FIG. 8, the density of hatching corresponds to an amount of displacement resulting from vibrations, for example, a portion with thick hatching corresponds to a portion with a large amount of displacement, and thus, the outermost-layer lens 1 has a large amount of displacement.

According to the exemplary aspect, the optical device 10 can be configured to switch between the foreign-matter removal mode and the heating mode using the excitation circuit 6. For example, the optical device 10 may switch between the foreign-matter removal mode and the heating mode based on images captured by the imaging device 20. More specifically, the optical device 10 may preliminarily store an image taken when foreign matter, such as raindrops, mud, or dust, adheres to the outermost-layer lens 1 and an image taken when foreign matter, such as ice or frost, adheres to the outermost-layer lens 1, and may switch between the foreign-matter removal mode and the heating mode based on the current situation corresponding to either one of these images.

### Modification Example

In the optical device 10 according to the embodiment, the supporter 33 has an S-shaped cross section. However, instead of an S-shaped cross section, the supporter may have any other shape that does not cause stress to concentrate on the vibrator in alternative aspects. For example, the supporter 33 may have a cross section with multiple S shapes connected together. Alternatively, the supporter 33 may have any shape that reduces a portion on which stress concentrates, for example, a curved shape with a cross section of a half of a letter S.

The imaging unit 100 according to the above embodiment may include, for example, a camera, a light detection and ranging (LiDAR), or a radar. Alternatively, multiple imaging units 100 may be arranged side by side.

It is also noted that the imaging unit 100 according to the above embodiment is not limited to the imaging unit to be installed on a vehicle, but is similarly applicable to any imaging unit that includes an optical device and an imaging device oriented to have a light-transparent body in a direction of the field of view, and that is to remove foreign matter on the light-transparent body.

### Exemplary Aspect

In an first exemplary aspect (1), an optical device is provided that includes a light-transparent body configured to transmit light of a predetermined wavelength; a housing configured to hold the light-transparent body; a vibrator that contacts the light-transparent body held by the housing; and a piezoelectric device disposed at the vibrator and configured to vibrate the vibrator. The vibrator is a tubular body having a first end that is in contact with the light-transparent body, and a second end that is opposite to the first end, and at which the piezoelectric device is disposed. Moreover, in a heating mode among a plurality of vibration modes of vibrating the light-transparent body, the vibrator is configured to vibrate the light-transparent body at a vibration acceleration within a range of more than or equal to 3.0×10⁶ m/s² to less than or equal to 3.0×10⁸ m/s² at a natural vibration frequency of the light-transparent body.

In a second exemplary aspect (2), the optical device according to (1) is configured such that when vibrating the light-transparent body in the heating mode, the vibrator vibrates the light-transparent body to cause the light-transparent body to have maximum displacement resulting from vibrations.

In a third exemplary aspect (3), the optical device according to (1) or (2) is configured such that when the light-transparent body is vibrated in the heating mode, an electromechanical coupling coefficient between the light-transparent body and the piezoelectric device is within a range of more than or equal to 0% and less than or equal to 6% or a resonant resistance is more than or equal to 60 Ω.

In a fourth exemplary aspect (4), the optical device according to any one of (1) to (3) is configured such that the vibrator vibrates the light-transparent body in a foreign-matter removal mode among the plurality of vibration modes at a resonant frequency at which a center portion of the light-transparent body serves as a vibration antinode and at which an edge portion of the light-transparent body held at the housing serves as a vibration node, or the vibrator vibrates an entirety of the light-transparent body held at the housing in a direction of a field of view.

In a fifth exemplary aspect (5), the optical device according to (4) further comprises a switching portion that switches a mode of vibrating the light-transparent body between the plurality of vibration modes. In this aspect, the switching portion switches between the foreign-matter removal mode and the heating mode based on an image obtained by an imaging device.

In a sixth exemplary aspect (6), an imaging unit is provided that comprising: the optical device according to any one of (1) to (5); and an imaging device oriented to have the light-transparent body in a direction of a field of view.

In general, the exemplary embodiment disclosed herein is considered exemplary in all respects and not limitative. Thus, throughout this description, the embodiment and examples shown should be considered as exemplars, rather than limitations on the apparatus disclosed or claimed. Although many of the examples presented herein involve specific combinations of elements, it should be understood that those acts and those elements may be combined in other ways to accomplish the same objectives.

### REFERENCE SIGNS LIST

1 outermost-layer lens
2 housing
2a flat spring
2b retainer
3 vibrator
4 inner layer lens
5 piezoelectric device
6 excitation circuit
10 optical device
20 imaging device
100 imaging unit

1. An optical device comprising:
a light-transparent body configured to transmit light of a predetermined wavelength;
a housing configured to hold the light-transparent body;
a vibrator including a tubular body having a first end that is configured to contact the light-transparent body held by the housing; and
a piezoelectric device that is disposed at a second end of the tubular body of the vibrator and that is configured to vibrate the vibrator,
wherein, in a heating mode of a plurality of vibration modes, the vibrator is configured to vibrate the light-transparent body at a vibration acceleration within a range of more than or equal to 3.0×10⁶ m/s² and less than or equal to 3.0×10⁸ m/s² at a natural vibration frequency of the light-transparent body.

2. The optical device according to claim 1, wherein the second end of the tubular body is opposite the first end of the tubular body.

3. The optical device according to claim 1, wherein, in the heating mode, the vibrator is configured to vibrate the light-transparent body to cause the light-transparent body to have maximum displacement in response to vibrations.

4. The optical device according to claim 1, wherein, in the heating mode, an electromechanical coupling coefficient between the light-transparent body and the piezoelectric device is within a range of more than or equal to 0% and less than or equal to 6%.

5. The optical device according to claim 1, wherein, in the heating mode, a resonant resistance is more than or equal to 60 Ω.

6. The optical device according to claim 1, wherein the vibrator is configured to vibrate the light-transparent body in a foreign-matter removal mode of the plurality of vibration modes at a resonant frequency at which a center portion of the light-transparent body is configured as a vibration antinode and at which an edge portion of the light-transparent body held at the housing is configured as a vibration node.

7. The optical device according to claim 1, wherein the vibrator is configured to vibrate the light-transparent body in a foreign-matter removal mode of the plurality of vibration modes at which the vibrator is configured to vibrate an entirety of the light-transparent body held at the housing in a direction of a field of view.

8. The optical device according to claim 6, further comprising:
a switching controller configured to switch a mode of vibrating the light-transparent body between the plurality of vibration modes,
wherein the switching controller is configured to switch between the foreign-matter removal mode and the heating mode based on an image obtained by an imaging device.

9. The optical device according to claim 8, wherein the switching controller is an excitation circuit that is configured to drive the piezoelectric device between the foreign-matter removal mode and the heating mode.

10. The optical device according to claim 7, further comprising:
a switching controller configured to switch a mode of vibrating the light-transparent body between the plurality of vibration modes,
wherein the switching controller is configured to switch between the foreign-matter removal mode and the heating mode based on an image obtained by an imaging device.

11. The optical device according to claim 10, wherein the switching controller is an excitation circuit that is configured to drive the piezoelectric device between the foreign-matter removal mode and the heating mode.

12. The optical device according to claim 1, wherein the tubular body of the vibrator comprises a supporter that connects the first end to the second end portion and comprises an S-shaped cross section.

13. The optical device according to claim 1, wherein the light-transparent body is a lens held at an end portion of a flat spring extending from the housing.

14. An imaging unit comprising:
the optical device according to claim 1; and
an imaging device oriented to have the light-transparent body in a direction of a field of view.

15. The imaging unit according to claim 14, wherein, in the heating mode, the vibrator is configured to vibrate the light-transparent body to cause the light-transparent body to have maximum displacement in response to vibrations.

16. The imaging unit according to claim 14, wherein, in the heating mode, an electromechanical coupling coefficient between the light-transparent body and the piezoelectric device is within a range of more than or equal to 0% and less than or equal to 6%.

17. The imaging unit according to claim 14, wherein, in the heating mode, a resonant resistance is more than or equal to 60 Ω.

18. The imaging unit according to claim 14, wherein the vibrator is configured to vibrate the light-transparent body in a foreign-matter removal mode of the plurality of vibration modes at a resonant frequency at which a center portion of the light-transparent body is configured as a vibration antinode and at which an edge portion of the light-transparent body held at the housing is configured as a vibration node.

19. The imaging unit according to claim 18, wherein the optical device further comprises:
a switching controller configured to switch a mode of vibrating the light-transparent body between the plurality of vibration modes,
wherein the switching controller is configured to switch between the foreign-matter removal mode and the heating mode based on an image obtained by an imaging device.

20. The imaging unit according to claim 19, wherein the switching controller is an excitation circuit that is configured to drive the piezoelectric device between the foreign-matter removal mode and the heating mode.
